(19) United States
(12) Patent Application Publication
(10) Pub. No.: US 2017/0067432 A1
(43) Pub. Date: Mar. 9, 2017

(54) APPARATUS AND METHOD FOR CONTROLLING ENGINE STOP OF HYBRID ELECTRIC VEHICLE

(71) Applicants: Kia Motors Corporation, Seoul (KR); Hyundai Motor Company, Seoul (KR)

(72) Inventors: Sang Joon Kim, Seoul (KR); Seong Ik Park, Seoul (KR)

(73) Assignees: Hyundai Motor Company, Seoul (KR); Kia Motors Corporation, Seoul (KR)

(21) Appl. No.: 14/951,720

(22) Filed: Nov. 25, 2015

(30) Foreign Application Priority Data
Sep. 4, 2015 (KR) 10-2015-0125618

(51) Int. Cl. F02N 11/08; B60K 6/24; F02D 41/26; B60W 20/40

(52) U.S. Cl. CPC F02N 11/0833; B60W 20/40; B60K 6/24; F02D 41/26; F02N 11/0811; B60Y 2200/92; F02N 2300/104

(57) ABSTRACT

An apparatus and a method for controlling an engine stop of a hybrid electric vehicle are provided to charge the vehicle by advancing control completion time for the engine stop and using inertial energy of the engine. The method includes determining a sensing speed for executing the engine stop when required and determining a value of control timeout based on the sensing speed. A torque is applied to an HSG based on the sensing speed and the value of control timeout is compared with a counter value when the sensing speed is equal to or greater than a predetermined speed. The counter value is increased when the counter value is equal to or less than the value of control timeout. The sensing speed is redetermined, the torque application to the HSG is stopped and the counter value is reset when the counter value is greater than the control timeout value.

### CROSS-REFERENCE TO RELATED APPLICATION

This application claims priority to and the benefit of Korean Patent Application No. 10-2015-0125618 filed in the Korean Intellectual Property Office on Sep. 4, 2015, the entire contents of which are incorporated herein by reference.

### BACKGROUND

(a) Field of the Invention

The present invention relates to an apparatus and a method for controlling an engine stop of a hybrid electric vehicle, and more particularly, to an apparatus and a method for controlling an engine stop of a hybrid electric vehicle that controls a stable charging by advancing a time point of control completion for the engine stop and using inertial energy of the engine.

(b) Description of the Related Art

A hybrid vehicle is a type of vehicle that uses two or more different power sources and is generally driven by an engine that obtains a driving torque by fuel combustion and a motor that obtains a driving torque with battery power. Hybrid electric vehicles can be provided with optimum output torque, based on how the engine and the motor are operated while the vehicle is driven by the two power sources, that is, the engine and the motor. The hybrid electric vehicle repeatedly performs an engine start and an engine stop. Thus, rotational inertial force of the engine can be recovered by the motor connected to the engine after the engine stop.

In the conventional art, the engine stop control is performed by detecting a rotation speed of the engine, however, when the engine speed is detected incorrectly due to a malfunction of an engine speed sensor or a communication malfunction of controller area network (CAN), a reverse rotation of the engine may be generated. Moreover, hardware damage such as a catalyst may occur during reverse rotation of the engine.

The above information disclosed in this section is merely for enhancement of understanding of the background of the invention and therefore it may contain information that does not form the prior art that is already known in this country to a person of ordinary skill in the art.

### SUMMARY

The present invention provides an apparatus and a method for controlling an engine stop of a hybrid electric vehicle having advantages of preventing a reverse rotation of the engine and controlling a stable charging of the motor by advancing a time point of control completion for the engine stop and using inertial energy of the engine.

An exemplary embodiment of the present invention provides a method for controlling an engine stop of a hybrid electric vehicle including a motor and an engine as a power source that may include determining a sensing speed for executing the engine stop when the engine stop is required; determining a value of control timeout based on the sensing speed; applying a torque to a hybrid integrated starter-generator (HSG) based on the sensing speed; comparing the value of control timeout with a counter value when the sensing speed is equal to or greater than a predetermined speed; increasing the counter value when the counter value is equal to or less than the value of control timeout, redetermining the sensing speed; and stopping the application of the torque to the HSG and resetting the counter value when the counter value is greater than the value of control timeout.

The sensed speed for execute the engine stop may be determined based on a minimum speed among an engine speed and a HSG speed. The value of control timeout may be determined based on information mapped by a table of control time based on an initial sensing speed.

Another exemplary embodiment of the present invention provides an apparatus for controlling an engine stop of a hybrid electric vehicle including a motor and an engine as a power source that may include a driving information detector configured to detect a running state of the hybrid electric vehicle; a hybrid integrated starter-generator (HSG) configured to start the engine or generate power by an engine torque; and a controller configured to execute an engine stop control by adjusting a torque of the HSG when the engine stop is required based on a signal from the driving information detector.

Additionally, the controller may be configured to execute the engine stop control by determining a sensing speed for executing the engine stop and a value of control timeout, compare the value of control timeout with a counter value, repeatedly perform the engine stop control by increasing the counter value and redetermining the sensing speed when the counter value is equal to or less than the value of control timeout, and reset the value of control timeout by completing the engine stop control when the counter value is greater than the value of control timeout.

The controller may be configured to complete the engine stop control when the sensing speed is less than a predetermined speed. The controller may further be configured to apply a torque to the HSG based on the sensing speed when the engine stop control starts, and stop the applying the torque to the HSG when the engine stop control is completed. The controller may be configured to determine the sensing speed for executing the engine stop based on a minimum speed among an engine speed and a HSG speed. The controller may also be configured to determine the value of control timeout based on information mapped by a table of control time based on an initial sensing speed.

As described above, according to an exemplary embodiment of the present invention, a time point of control completion for the engine stop can be advanced, thereby stably charging the motor. In addition, a reverse rotation of the engine generated at the engine stop can be firmly prevented.

### BRIEF DESCRIPTION OF THE DRAWINGS

Since the accompanying drawings are provided only to describe exemplary embodiments of the present invention, it is not to be interpreted that the spirit of the present invention is limited to the accompanying drawings.

FIG. 1 is a schematic diagram of a hybrid system to which a method for controlling an engine stop of a hybrid electric vehicle is applied according to an exemplary embodiment of the present invention;

FIG. 2 is a block diagram of an apparatus for controlling an engine stop of a hybrid electric vehicle according to an exemplary embodiment of the present invention; and

FIG. 3 is a flowchart showing a method for controlling an engine stop of a hybrid electric vehicle according to an exemplary embodiment of the present invention.

### DETAILED DESCRIPTION

In the following detailed description, exemplary embodiments of the present invention have been shown and described, simply by way of illustration. As those skilled in the art would realize, the described exemplary embodiments may be modified in various different ways, all without departing from the spirit or scope of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numerals designate like elements throughout the specification.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that some of the methods may be executed by at least one controller/control unit. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, a controller, or the like. Examples of computer readable media include, but are not limited to, ROM, RAM, compact disc (CD)-ROMs, magnetic tapes, floppy disks, flash drives, smart cards, and optical data storage devices. The computer readable recording medium can also be distributed in network coupled computer systems so that the computer readable media is stored and executed in a distributed fashion, e.g., by a telematics server or a controller area network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

An exemplary embodiment of the present invention will hereinafter be described in detail with reference to the accompanying drawings.

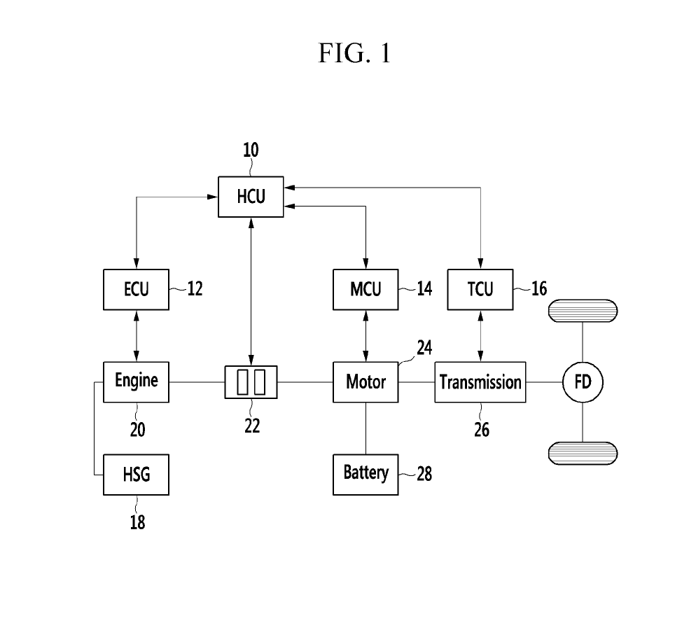

FIG. 1 is a schematic diagram of a hybrid system to which a method for controlling an engine stop of a hybrid electric vehicle is applied according to an exemplary embodiment of the present invention. The hybrid system as shown in FIG. 1 is an exemplary embodiment of the present invention for better comprehension and ease of description. Therefore, a method for controlling an engine stop of a hybrid electric vehicle according to an exemplary embodiment of the present invention may not only be applied to the hybrid system as shown in FIG. 1, but may also be applied to all other hybrid systems.

As shown in FIG. 1, the hybrid system to which a method for controlling an engine stop of a hybrid electric vehicle is applied according to an exemplary embodiment of the present invention may include a hybrid control unit (HCU) 10, an electronic control unit (ECU) 12, a motor control unit (MCU) 14, a transmission control unit (TCU) 16, a hybrid integrated starter-generator (HSG) 18, an engine 20, an engine clutch 22, a motor 24, a transmission 26, and a battery 28.

The HCU 10 may be configured to operate the other controllers which mutually exchange information in an entire operation of a hybrid electric vehicle, and thus, the HCU 10 may be configured to adjust output torque of the engine 20 and the motor 24 by cooperating with the other controllers. The ECU 12 may be configured to operate the engine 20 based on conditions of the engine 20, such as a demand torque of a driver, a coolant temperature, and an engine torque. The MCU 14 may be configured to operate the motor 24 based on a demand torque of a driver, a driving mode of the hybrid electric vehicle, and a state of charge (SOC) condition of the battery 28. The TCU 16 may be configured to operate the transmission 26 such as speed ratios of the transmission 26 based on output torque of the engine 20 and the motor 24, and an amount of regenerative braking.

The engine 20 may be configured to output power as a power source while turned on and may be connected to a hybrid integrated starter-generator (HSG) 18 igniting fuel of a cylinder disposed within the engine 20. The HSG 18 may be operated as a motor to start the engine 20 or when a surplus output occurs in a state that maintains starting of the hybrid electric vehicle, the HSG 18 may be operated as a generator to charge a battery. The engine clutch 22 may be disposed between the engine 20 and the motor 24 to receive a control signal from the HCU 10, and selectively connect the engine 20 and the motor 24 based on a driving mode of the hybrid electric vehicle. The motor 24 may be operated by a 3-phase alternating current (AC) voltage applied from the battery 28 by an inverter to generate torque, and may operate as a power generator and supply regenerative energy to the battery 28 in a coast-down mode.

The transmission 26 may be configured to supply a sum of an output torque of the engine 20 and an output torque of the motor 24 determined by coupling and releasing of the engine clutch 22 as an input torque and select any shift gear based on a vehicle speed and a driving condition to output driving force to a driving wheel and maintain driving. The battery 28 may include a plurality of unit cells, and may be configured to store a high voltage for supplying a voltage to the motor 24, for example, about 400 V or 450 V DC.

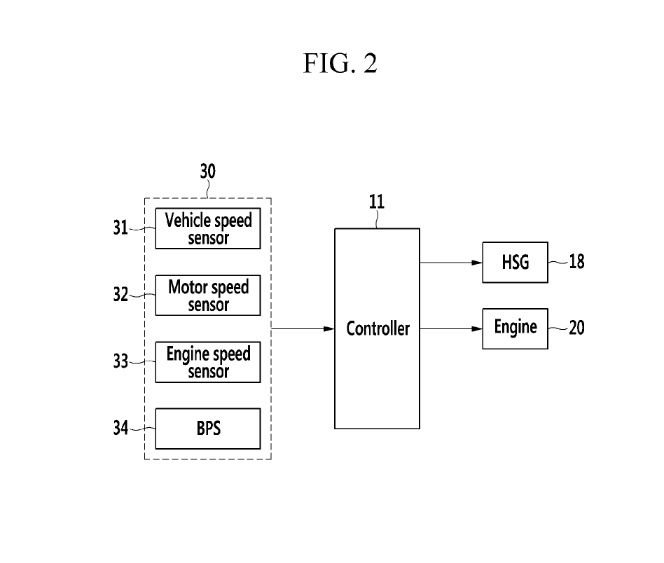

The hybrid system as described above is obvious to a person of ordinary skill in the art, so a detailed explanation thereof will be omitted. FIG. 2 is a block diagram of an apparatus for controlling an engine stop of a hybrid electric vehicle according to an exemplary embodiment of the present invention. As shown in FIG. 2, an apparatus for controlling an engine stop of a hybrid electric vehicle according to an exemplary embodiment of the present invention may include a HSG 18, an engine 20, a driving information detector 30 and a controller 11. The controller 11 may be configured to operate the HSG 18, the engine 20, and the driving information detector 30.

Processes in the method for controlling torque reduction of the hybrid electric vehicle according to an exemplary embodiment of the present invention to be described below may be performed by integrating or subdividing due to each controller. Therefore, for convenience of description, in this specification and claims, many controllers provided in the hybrid electric vehicle are referred to as the controller 11. The hybrid electric vehicle to which an exemplary embodiment of the present invention is applied includes at least one engine 20 and at least one motor 24. In addition, the hybrid electric vehicle provides a driving mode in which the engine 20 and the motor 24 operate separately or simultaneously as a power source. For this purpose, the engine clutch may be disposed between the engine 20 and the motor 24 to selectively connect the engine 20 and the motor 24.

The driving information detector 30 may be configured to detect a running state of the hybrid electric vehicle and demand information of a driver and may include a vehicle speed sensor 31, a motor speed sensor 32, an engine speed sensor 33 and a brake pedal position sensor (BPS) 34. The vehicle speed sensor 31 may be configured to detect a speed of the vehicle, and transmit a corresponding signal to the controller 11. The motor speed sensor 32 may be configured to detect a rotation speed of the motor 24, and transmit a corresponding signal to the controller 11. The engine speed sensor 33 may be configured to detect a rotation speed of the engine 20, and transmit a corresponding signal to the controller 11.

Additionally, the brake pedal position sensor 34 may be configured to continuously detect a position value of a brake pedal and transmit a monitoring signal to the controller 11. The position value of the brake pedal may be 100% when the brake pedal is fully engaged, and the position value of the brake pedal may be 0% when the brake pedal is disengaged. The controller 11 may be configured to execute an engine stop control by adjusting a torque of the HSG 18 when the engine stop is required based on a signal from the driving information detector 30.

The controller 11 may be configured to determine a sensing speed for executing the engine stop to perform the engine stop control, and determine a value of control timeout to compare thereof with a counter value. Further, the controller 11 may be configured to repeatedly execute the engine stop control by increasing the counter value and redetermining the sensing speed when the counter value is equal to or less than the value of control timeout, and reset the value of control timeout by completing the engine stop control when the counter value is greater than the value of control timeout. Herein, the controller 11 may be configured to determine the sensing speed for executing the engine stop based on a minimum speed among an engine speed and a HSG speed, and may complete the engine stop control when the sensing speed is less than a predetermined speed.

In addition, the controller 11 may be configured to apply a torque to the HSG based on the sensing speed when the engine stop control starts, and stop the application of the torque to the HSG when the engine stop control is completed. For these purposes, the controller 11 may be implemented as at least one processor that is operated by a predetermined program, and the predetermined program may be programmed to perform each step of a method for controlling an engine stop of a hybrid electric vehicle according to an exemplary of the present invention.

Various exemplary embodiments described herein may be implemented within a recording medium that may be read by a computer or a similar device by using software, hardware, or a combination thereof, for example. According to hardware implementation, the embodiments described herein may be implemented by using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electric units designed to perform any other functions.

According to software implementation, embodiments such as procedures and functions described in the present exemplary embodiments may be implemented by separate software modules. Each of the software modules may perform one or more functions and operations described in the present invention. A software code may be implemented by a software application written in an appropriate program language.

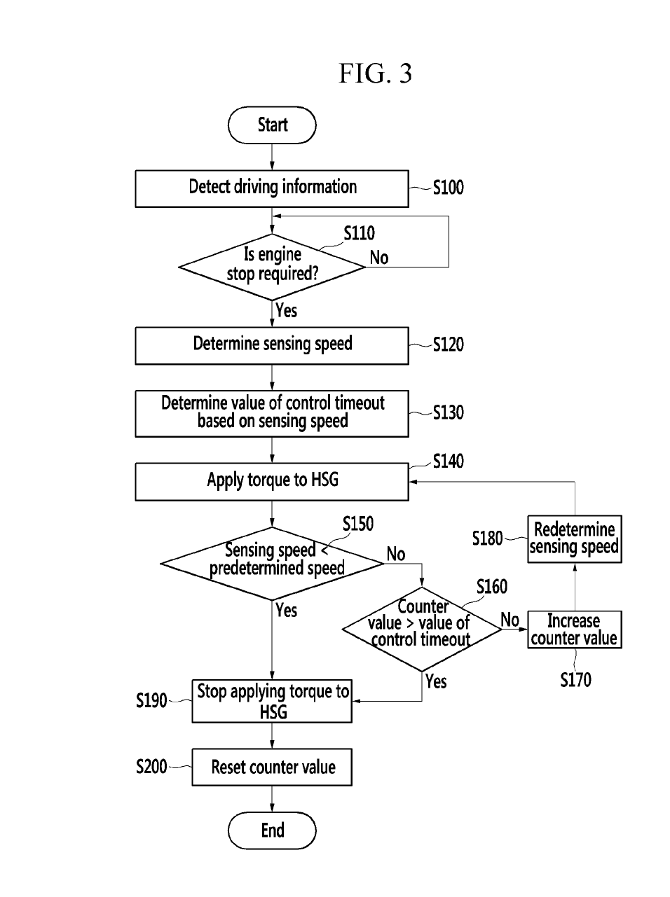

Hereinafter, a method for controlling an engine stop of the hybrid electric vehicle according to an exemplary embodiment of the present invention will be described in detail with reference to FIG. 3. FIG. 3 is a flowchart showing a method for controlling an engine stop of a hybrid electric vehicle according to an exemplary embodiment of the present invention. As shown in FIG. 3, a method for controlling an engine stop of a hybrid electric vehicle according to an exemplary embodiment of the present invention may begin with detecting driving information for an engine stop control at step S100.

Further, the controller 11 may be configured to determine whether the engine stop is required based on the detected driving information detected at step S110. When the engine stop is required at the step S110, the controller 11 may be configured to determine a sensing speed for executing the engine stop at step S120. The sensing speed for executing the engine stop may be determined based on a minimum speed among an engine speed and a HSG speed. A sensing speed of the engine 20 and a sensing speed of the HSG 18 may have a difference between sensing positions due to distortion of a shaft or a belt slip. Therefore, the minimum speed among the sensing speed of the engine 20 and the sensing speed of the HSG 18 may be used to improve control robustness.

When the sensing speed is determined at the step S120, the controller 11 may be configured to determine a value of control timeout based on the sensing speed at step S130. The value of control timeout may be determined based on information mapped by a table of control time based on an initial sensing speed obtained through a predetermined test. In other words, the value of control timeout may be determined based on the initial sensing speed and may be maintained during a method for controlling the engine stop of the hybrid electric vehicle according to an exemplary embodiment of the present invention is performed.

In addition, when the sensing speed is determined at the step S120, the controller 11 may be configured apply a torque to the HSG 18 based on the sensing speed at step S140. After that, the controller 11 may be configured to compare the sensing speed with a predetermined speed at step S150. The predetermined speed may be a speed at a time point when the engine stop control is completed. Thus, the predetermined speed may be about 0 (zero) or a value close to 0. When the sensing speed is less than the predetermined speed at the step S150, the controller 11 may be configured to stop the application of the torque to the HSG 18 at step S190. In other words, the engine speed may be sufficiently low to thus complete the engine stop control.

Furthermore, when sensing speed is equal to or greater than the predetermined speed at the step S150, the controller 11 may be configured to compare the value of control timeout with a counter value at step 160. Herein, both the counter value and the value of control timeout are functions of time, the counter value may be set as 0, and the value of control timeout may be set based on information mapped by a table of control time based on an initial sensing speed.

When the counter value is greater than the value of control timeout at the step S160, the controller 11 may proceed to the step S190 and may be configured to stop the application of the torque to the HSG 18. Further, when the counter value is equal to or less than the value of control timeout at the step S160, the controller 11 may be configured to increase the counter value at step S170, and redetermine the sensing speed at step S180. The controller 11 may then return the process to the step S140 and repeatedly perform the step S140 to the step S160.

For example, when a malfunction is generated while sensing a speed of the engine 20 or the HSG 18 or a communication malfunction of CAN is generated, the speed of the engine 20 or the HSG 18 may be detected incorrectly. Thus, a difference between a real speed of the engine 20 or the HSG 18 and the sensing speed of the engine 20 or the HSG 18 may occur. In this circumstance, to prevent reverse rotation of the engine 20, the controller 11 according to the exemplary embodiment of the present invention may be configured to stop the engine stop control when controlling more than a predetermined time by comparing the value of control timeout with the counter value. When the engine stop control is completed by stopping the application of the torque to the HSG 18 at the step S190, the controller 11 may be configured to reset the counter value at step S200, a method for controlling an engine stop of a hybrid electric vehicle according to an exemplary embodiment of the present invention may be finished.

As described above, according to an exemplary embodiment of the present invention, a time point of control completion for the engine stop may be advanced, thereby more stably charging the motor. In addition, a reverse rotation of the engine generated at the engine stop may be prevented.

While this invention has been described in connection with what is presently considered to be exemplary embodiments, it is to be understood that the invention is not limited to the disclosed exemplary embodiments. On the contrary, it is intended to cover various modifications and equivalent arrangements included within the spirit and scope of the appended claims.

What is claimed is:

1. A method for controlling an engine stop of a hybrid electric vehicle including a motor and an engine as a power source, comprising:
determining, by a sensor, a sensing speed for executing the engine stop when the engine stop is required;
determining, by a controller, a value of control timeout based on the sensing speed;
applying, by the controller, a torque to a hybrid integrated starter-generator (HSG) based on the sensing speed;
comparing, by the controller, the value of control timeout with a counter value when the sensing speed is equal to or greater than a predetermined speed;
increasing, by the controller, the counter value when the counter value is equal to or less than the value of control timeout, and redetermining the sensing speed; and
stopping, by the controller, the application of the torque to the HSG and resetting the counter value when the counter value is greater than the value of control timeout.

2. The method of claim 1, wherein the sensing speed for executing the engine stop is determined based on a minimum speed between an engine speed and a HSG speed.

3. The method of claim 1, wherein the value of control timeout is determined based on information mapped by a table of control time based on an initial sensing speed.

4. An apparatus for controlling an engine stop of a hybrid electric vehicle including a motor and an engine as a power source, comprising:
a driving information detector configured to detect a running state of the hybrid electric vehicle;
a hybrid integrated starter-generator (HSG) configured to start the engine or generate power by an engine torque; and
a controller configured to execute an engine stop control by adjusting a torque of the HSG when the engine stop is required based on a signal from the driving information detector,
wherein the controller is configured to execute the engine stop control by determining a sensing speed for executing the engine stop and a value of control timeout, compare the value of control timeout with a counter value, repeatedly execute the engine stop control by increasing the counter value and redetermining the sensing speed when the counter value is equal to or less than the value of control timeout, and reset the value of control timeout by completing the engine stop control when the counter value is greater than the value of control timeout.

5. The apparatus of claim 4, wherein the controller is configured to complete the engine stop control when the sensing speed is less than a predetermined speed.

6. The apparatus of claim 4, wherein the controller is configured to apply a torque to the HSG based on the sensing speed when the engine stop control starts, and stop the applying the torque to the HSG when the engine stop control is completed.

7. The apparatus of claim 4, wherein the controller is configured to determine the sensing speed for executing the engine stop based on a minimum speed between an engine speed and a HSG speed.

8. The apparatus of claim 4, wherein the controller is configured to determine the value of control timeout based on information mapped by a table of control time based on an initial sensing speed.

9. A non-transitory computer readable medium containing program instructions executed by a controller for executing an engine stop of a hybrid electric vehicle including a motor and an engine as a power source, the computer readable medium comprising:
program instructions that control a sensor to determine a sensing speed for executing the engine stop when the engine stop is required;
program instructions that determine a value of control timeout based on the sensing speed;
program instructions that apply a torque to a hybrid integrated starter-generator (HSG) based on the sensing speed;
program instructions that compare the value of control timeout with a counter value when the sensing speed is equal to or greater than a predetermined speed;
program instructions that increase the counter value when the counter value is equal to or less than the value of control timeout, and redetermining the sensing speed; and
program instructions that stop the application of the torque to the HSG and resetting the counter value when the counter value is greater than the value of control timeout.

10. The non-transitory computer readable medium of claim 9, wherein the sensing speed for executing the engine stop is determined based on a minimum speed between an engine speed and a HSG speed.

11. The non-transitory computer readable medium of claim 9, wherein the value of control timeout is determined based on information mapped by a table of control time based on an initial sensing speed.
